(19) United States
(12) Patent Application Publication
(10) Pub. No.: US 2009/0230188 A1
(43) Pub. Date: Sep. 17, 2009

(54) AUTOMATIC INVENTORY ACCESS METHOD

(76) Inventor: Wen-Tsan Wang, Taipei City (TW)

Correspondence Address: LEONG C LEI, PMB # 1008, 1867 YGNACIO VALLEY ROAD, WALNUT CREEK, CA, 94598, US

(21) Appl. No.: 12/047,326

(22) Filed: Mar. 13, 2008

(51) Int. Cl. G06F 19/00

(52) U.S. Cl. 235/385

(57) ABSTRACT

An automatic inventory access method used with a computer system is disclosed to include the steps of: (a) using the computer system to pick up the image of every article to be stored in an inventory station for enabling the obtained images to be stored in the computer system in the form of an electronic file, (b) classifying every article with a respective article number, (c) storing every classified article in one respective storage compartment in the inventory station, (d) operating the computer system to input the required conditions so that the computer system compares the input data with related information searched through the Internet, and then selecting the images of related articles for display on a display screen of the computer system, (e) operating the computer system to simulate the use of every displayed article so as to select every desired article from the displayed articles, and (f) giving a command to the computer system so that an access unit is driven to carry very selected article from the inventory station to the user.

### BACKGROUND OF THE INVENTION

(a) Technical Field of the Invention

The present invention relates to inventory control technology and more particularly, to an automatic inventory access method for the management and simulation of use of personal articles of a person or family or product samples of a company by means of a computer system.

(b) Description of the Prior Art

Before going to visit a particular place, one may worry about which dress to wear and which accessory to match. More particularly, a female may spend a lot of time in selecting the clothing and related accessories to wear.

Further, in a family having many family members, it is difficult to manage the clothing and related articles of every family member. When all the clothing and related articles of all the family members of the family are stored in one wardrobe, every family member may have to spend a lot of time to find one desired cloth or personal article. If all the clothing and related articles of every family member are stored in one respective wardrobe, it requires much installation space for the installation of the wardrobes.

Further, when one is going to participate a particular activity, one may be difficult to decide which cloth or article to wear or to carry. For example, before going to play a golf game, one may spend a lot of time in determining the selection of the clothes, shoes, and other related equipment and/or accessories.

Further, a company may have a display room for showing product samples. The display samples may have to be frequently changed to fit different clients. The management of the inventory and display control of the product samples is not easy. Improper management of the inventory and display control of the product samples affects the company's business development.

### SUMMARY OF THE INVENTION

The primary purpose of the present invention is to provide an automatic inventory access method, which helps management and use of personal articles of a person or family or product samples of a company by means of a computer system, allowing the user to simulate the use or display of every selected item through a virtual reality platform.

The automatic inventory access method is used with a computer system that has installed therein an Internet IP information integration unit, a virtual reality simulation unit, an image processing unit and an access unit, which corresponds to an inventory station in such a manner that the access unit is operable to store products in the inventory station and to take every storage product out of the inventory station.

The automatic inventory access method comprises the steps of: (a) using the image processing unit to pick up the image of every article to be stored in the inventory station and to convert the image into an electronic file for enabling the electronic file to be stored in the computer system; (b) classifying every article with a respective article number; (c) storing every classified article in one respective storage compartment in the inventory station by means of the access unit; (d) operating the computer system to input the required conditions so that the computer system compares the input data with related information searched through the Internet by means of the Internet IP information integration unit, and then selecting the images of related articles for display on a display screen of the computer system; (e) operating the computer system to simulate the use of every displayed article through the virtual reality simulation unit so as to select every desired article from the displayed articles; and (f) giving a command to the access unit through the computer system so that the access unit carries every selected article from the inventory station to the user subject to the inputted article number.

This automatic inventory control method is practical for the inventory control of one's personal clothing and related accessories or the clothing and related accessories of a family. This automatic inventory control method is also practical for the inventory and display control of product samples of a company.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a system block diagram of the present invention.

### DETAILED DESCRIPTION OF THE PREFERRED EMBODIMENTS

The following descriptions are of exemplary embodiments only, and are in any way. Rather, the following description provides a convenient illustration for implementing exemplary embodiments of the invention. Various changes to the described embodiments may be made in the function and arrangement of the elements described without departing from the scope of the invention as set forth in the appended claims.

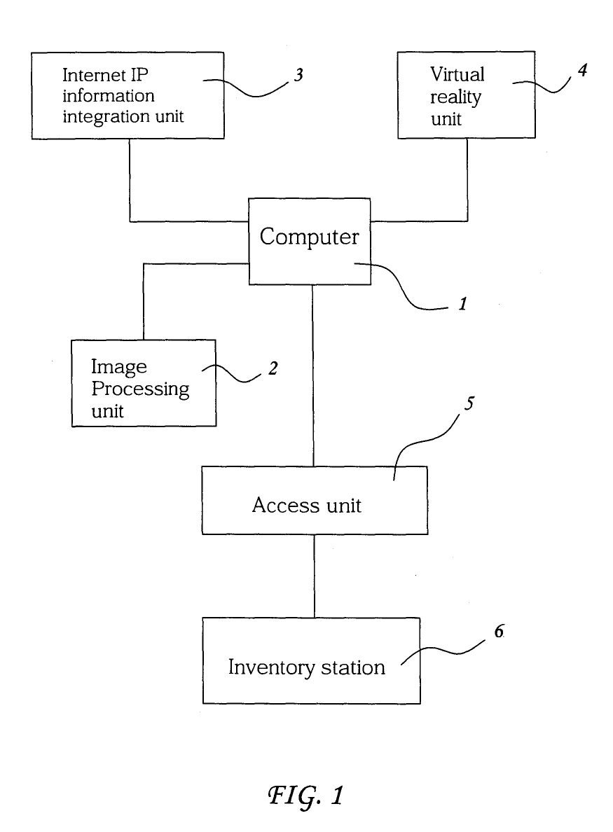

Referring to FIG. 1, an automatic inventory control method in accordance with the present invention is to be used with a computer 1 that has installed therein an Internet IP information integration unit 3, a virtual reality simulation unit 4, an image processing unit 2 and an access unit 5. The access unit 5 corresponds to an inventory station 6 in such a manner that the access unit 5 is operable to store products in the inventory station 6 or to take products out of the inventory station 6. The access unit 5 can be a mechanical arm, conveyer, or any means capable of delivering storage items. The inventory station 6 can be a wardrobe, locker room, storage cabinet, or the like, having classified storage compartments convenient for ABC classified management.

The internet IP information integration unit 3 allows the user to connect the computer 1 to the Internet so as to search related information from particular web sites, for example, to enter the web site of a weather bureau web site and to search for the weather data over a predetermined number of days including the present day, to link to a transportation and communication unit and to search for traffic conditions of important line of communications, or to link to related web sites and to search for number of visitors of landscapes, or to link to a stadium web site and to search for the information the stadium issued. The Internet IP information integration unit 3 can be kept connected to the Internet constantly, and can also be set to automatically update the information.

The virtual reality simulation unit 4 can be controlled to create a virtual reality platform when desired, so that a simulation of use of the product that is selected through the computer 1 can be performed through the virtual reality simulation unit 4 and the user can determine whether or not to pick up the selected product from the inventory station 6 subject to the result of the simulation.

The automatic inventory control method includes the step of (a) using the image processing unit 2 to pick up the image of every article to be stored in the inventory station 6 and to convert the image into an electronic file for enabling the electronic file to be stored in the computer 1, (b) classifying every article with a respective code number subject to owner-based or product type-based category, and (c) storing every classified article in one respective storage compartment in the inventory station 6 by means of the access unit 5.

The automatic inventory control method further includes the step of (d) the user operating the computer 1 to input the required conditions so that the computer 1 compares the input data with related information searched through the Internet and then selects the images of related articles for display on the display screen thereof, (e) the user operating the computer 1 to simulate the use of every displayed article through the virtual reality simulation unit 4 so as to select the desired one or ones from the displayed articles, (f) the user giving a command to the access unit 5 through the computer 1 so that the access unit 5 carries the selected article from the inventory station 6 to the user subject to the inputted article number.

In one example of the invention, the automatic inventory control method is used for the inventory control of one's personal clothing (or the clothing of one's family) such as clothes, hats, scarves, neckties, etc. The user classifies all the clothes with a respective article number, and then picks up the images of all the clothes and converts the images into an electronic file by means of the image processing unit 2 for storage in the computer, and then the user stores the clothes in the inventory station 6 as classified. The Internet IP information integration unit 3 is linked to a weather bureau web site for fetching the latest weather information. When the user is going to visit a particular place, the user can then operate the computer to fetch the local weather information of the place to be visited and then to display the images of the clothing selected subject to the weather information and to simulate the use of every displayed article through the virtual reality simulation unit 4 so as to select the desired article or articles from the displayed articles, and then the user gives a command to the access unit 5 through the computer 1 so that the access unit 5 carries the selected article or articles from the inventory station 6 to the user subject to the inputted article number.

In another example of the present invention, the automatic inventory control method is used for the inventory control of one's personal golf sportswear, including golf clubs, golf clothing, golf shoes and other related accessories. The user classifies all the personal golf wear with a respective article number, and then picks up the images of all the clothes and converts the images into an electronic file by means of the image processing unit 2 for storage in the computer, and then the user stores the clothes in the inventory station 6 as classified. The Internet IP information integration unit 3 can be linked to a golf course and the local weather bureau web site for fetching the latest golf course information and related weather forecast. When the user is going to play the golf game, the user can then operate the computer to fetch the latest weather report and golf course information and then to display the images of certain articles selected subject to the weather report and golf course information and to simulate the use of every displayed article through the virtual reality simulation unit 4 so as to select the desired article or articles from the displayed articles, and then the user gives a command to the access unit 5 through the computer 1 so that the access unit 5 carries the selected article or articles from the inventory station 6 to the user subject to the inputted article number.

In still another application of the present invention, the automatic inventory control method is used in a company for the inventory and display control of the company's product samples. The user classifies every product sample with a respective article number, and then picks up the images of all the product samples and converts the images into an electronic file by means of the image processing unit 2 for storage in the computer, and then the user stores the product samples in the inventory station (sample room) 6 as classified. The Internet IP information integration unit 3 can be linked to a database that has stored therein the purchase data of the clients of the company. When one client visits the company, the user can then operate the computer to display the images of certain articles selected subject the past purchase record and to simulate the presentation of every displayed article through the virtual reality simulation unit 4 so that the client can to select the desired article or articles from the displayed articles. Thereafter, the user gives a command to the access unit 5 through the computer 1 subject to the client's selection so that the access unit 5 carries the selected article or articles from the inventory station 6 to the client subject to the inputted article number.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automatic inventory access method used with a computer system that has installed therein an Internet IP information integration unit, a virtual reality simulation unit, an image processing unit and an access unit, which corresponds to an inventory station in such a manner that the access unit is operable to store products in the inventory station and to take every storage product out of the inventory station, the automatic inventory access method comprising the steps of:
(a) using said image processing unit to pick up the image of every article to be stored in said inventory station and to convert the image into an electronic file for enabling the electronic file to be stored in said computer system;
(b) classifying every article with a respective article number;
(c) storing every classified article in one respective storage compartment in said inventory station by means of said access unit;
(d) operating said computer system to input the required conditions so that said computer system compares the input data with related information searched through the Internet by means of said Internet IP information integration unit, and then selecting the images of related articles for display on a display screen of said computer system;
(e) operating said computer system to simulate the use of every displayed article through said virtual reality simulation unit so as to select every desired article from the displayed articles; and
(f) giving a command to said access unit through said computer system so that said access unit carries every selected article from said inventory station to the user subject to the inputted article number.
